(19) United States
(12) Patent Application Publication
(10) Pub. No.: US 2023/0017033 A1
(43) Pub. Date: Jan. 19, 2023

(54) BATTERY WITH INTEGRATED BUS BAR COOLING SYSTEM AND MOTOR VEHICLE

(71) Applicant: AUDI AG, Ingolstadt (DE)

(72) Inventor: Jens FRONEMANN, Simmelsdorf (DE)

(73) Assignee: AUDI AG, Ingolstadt (DE)

(21) Appl. No.: 17/865,687

(22) Filed: Jul. 15, 2022

(30) Foreign Application Priority Data
Jul. 15, 2021 (DE) 102021118397.9

(51) Int. Cl. H01M 10/613; H01M 50/209; H01M 10/653; H01M 10/6554; H01M 10/6556; H01M 50/264; H01M 50/503; H01M 10/625; H01M 10/647

(52) U.S. Cl. CPC H01M 10/613; H01M 50/209; H01M 10/653; H01M 10/6554; H01M 10/6556; H01M 50/264; H01M 50/503; H01M 10/625; H01M 10/647; H01M 2220/20

(57) ABSTRACT

A battery for a motor vehicle, having battery housing with a first receiving area, a housing base which bounds the receiving area with respect to a first direction, and at least one first side wall arranged on the housing base, which bounds the receiving area with respect to a second direction, and at least one first cell stack is arranged in the first receiving area and has at least one first battery cell which has a first cell pole connection on an upper side. The first side wall is formed as a first cooling wall, and the battery has at least one heat conducting element and a coupling device which includes an electrical insulation, wherein the heat conducting element has a first connection area connected to the first cell pole connection of the at least one first battery cell via the coupling device and a second connection area arranged on the first cooling wall.

### FIELD

The disclosure relates to a battery for a motor vehicle, wherein the battery has a battery housing with a first receiving area, a housing base which bounds the receiving area with respect to a first direction, and at least one first side wall arranged at the housing base which bounds the receiving area with respect to a second direction. Further, the battery relates to at least one first cell stack including at least one first battery cell having at least one first cell pole connection on an upper side, wherein the at least one cell stack is disposed in the first receiving area. Furthermore, the disclosure also relates to a motor vehicle with such a battery.

### BACKGROUND

Batteries for motor vehicles, in particular high-voltage batteries, are known from the prior art. These usually comprise multiple battery cells housed in a battery housing. The battery cells can also be grouped as cell stacks and/or provided as cell modules. The battery cells are typically arranged in the housing so that their cell poles face away from the housing base. The battery housing continues to be cooled at the bottom by appropriate cooling water ducts. Cooling elsewhere, for example at the top of the cell poles, is often difficult because the cells are interconnected at the top, wherein so-called busbars, also referred to below as conductor rails, are used to connect the cell poles of adjacently arranged battery cells in an electrically conductive manner. Thus, cooling often takes place only at the bottom of the cell. The heat that is transferred from the cell to the busbar cannot be dissipated effectively in this way. Heat due to electrical losses at high continuous power levels in the busbars cannot be dissipated either. In addition, if a defect causes thermal runaway in a battery cell, resulting in extreme heating of the battery cell, this temperature can easily propagate through the electrically conductive busbars to the next battery cell, which can lead to thermal propagation of all battery cells.

Furthermore, possibilities for targeted cooling of the busbars are also known from the prior art. For this purpose, for example, cooling channels can be integrated directly into the busbars, through which an electrically non-conductive cooling liquid flows, as described for example in DE 10 2020 002 959 A1 and DE 10 2020 006 274 A1, or the busbars can be cooled by means of air cooling, whereby a corresponding air flow flowing around the busbars can be generated by means of a fan, as described for example in DE 10 2013 218 668 A1 or U.S. Pat. No. 9,692,091 B2.

The integration of cooling channels directly into the busbars is extremely costly, while air cooling provides relatively low cooling efficiency.

### SUMMARY

It is therefore the object of the present disclosure to provide a battery and a motor vehicle that enable the most efficient cooling of at least one battery cell in the simplest possible manner.

This object is solved by a battery and a motor vehicle with the features according to the disclosure.

A battery for a motor vehicle according to the disclosure has a battery housing with a first receiving area, a housing base which bounds the receiving area with respect to a first direction, and at least one first side wall arranged on the housing base which bounds the receiving area with respect to a second direction. Further, the battery comprises at least one first cell stack comprising at least one first battery cell having a first cell pole connection on an upper side, wherein the at least one first cell stack is disposed in the first receiving area. In addition, the first side wall is formed as a first cooling wall, and the battery further comprises a heat conducting element and coupling device comprising electrical insulation, wherein the heat conducting element has a first connection area connected to the first cell pole connection of the at least one first battery cell via the coupling device and a second connection area disposed on the first cooling wall.

Thus, cooling can be connected to the cell poles of the at least one first battery cell in a particularly simple and efficient manner. This not only enables cooling of the cell poles, but also, for example, of a busbar or conductor rail arranged at the first cell pole connection, which can also be referred to as a cell connector. By providing the electrical insulation via which the heat conducting element is coupled to the first cell pole connection, it is also advantageously possible to make the heat conducting element electrically conductive and thus also particularly well thermally conductive. To give a simple example, the heat conducting element may simply be formed as a metal rail or shaped metal sheet arranged on the first cooling wall, in particular on a side of the first cooling wall facing away from the housing base, on the one hand, and arranged on a conductor rail via the electrical insulation, on the other hand, which is in turn coupled to the first cell pole connection. In this way, no complex cooling channels need to be integrated in busbars and, in addition, this allows cell pole connections to be cooled much more efficiently than, for example, air cooling. Particularly if the first cell stack comprises, for example, several first battery cells which, as described at the beginning, can be interconnected via busbars, the connection of the cell pole connections to the cooling wall via the heat conducting element can also provide significantly better thermal decoupling of the individual battery cells which are electrically conductively connected to one another via conductor rails, since the heat generated in one battery cell is thus not conducted via the conductor rail to the next battery cell, but is instead dissipated at least to a large extent via the heat conducting element to the first cooling wall. This can also make it possible to significantly delay thermal propagation across all cells in the event of a battery cell thermal event. Thus, the disclosure makes it possible to cool cells, terminals, i.e. their cell pole connections, and busbars in a particularly simple and efficient manner. In the event of thermal runaway of a cell, neighboring cells are also not heated, thus preventing or delaying their thermal runaway. In addition, the disclosure can also be implemented in such a way that no coolant-carrying parts are located inside the battery, i.e. within the receiving area, so that leakage over service life is thus not possible.

The battery is preferably a high-voltage battery for a motor vehicle, in particular for an electric or hybrid vehicle. Furthermore, the battery may have not only one battery cell, but preferably multiple battery cells, as will be discussed in more detail later. The battery cells are preferably prismatic cells. For example, the battery cells can also be lithium-ion cells.

The first cell stack is preferably arranged in the first receiving area in such a way that the first cell pole connection does not face the housing base. In particular, the first cell stack is preferably arranged in the first receiving area in such a way that the first cell pole connection faces away from the housing base. The cell pole connection can face, for example, a housing cover. This enables a particularly compact and efficient overall arrangement. Theoretically, however, it is also conceivable that the at least one first battery cell is arranged in the receiving area in such a way that the first cell pole connection faces a side other than the upper side of the battery opposite the housing base.

Moreover, the first receiving area can be limited not only by a single first side wall, but by several side walls. For example, a second side wall may be provided which is opposite to the first and which also delimits the first receiving area with respect to the second direction. Also, two additional side walls may be provided to define the receiving area in a third direction. The first, second and third directions, as defined in more detail later, are preferably perpendicular to each other. The first direction can correspond to a vehicle upward direction, for example, when the battery is used as intended in a motor vehicle. The second direction and the third direction can correspond to a longitudinal vehicle direction and a transverse vehicle direction, or vice versa. In addition, the battery housing base can also be designed as a cooling base. For this purpose, it can be designed, for example, with cooling channels through which a cooling medium, in particular a cooling liquid such as water, can flow. Furthermore, the first cell pole connection may be a positive connection or a negative connection of the first battery cell. Preferably, the first battery cell has two cell pole connections on its upper side, namely the first cell pole connection and a second cell pole connection. Furthermore, these cell pole connections are also referred to as terminals.

At least one of these side walls surrounding the receiving area can now advantageously be used as a cooling wall. For example, to form the first side wall as a first cooling wall, it may simply be provided by a metal wall connected to a cooling device. This cooling device can be provided, for example, by the housing base, which is designed as a cooling base. This advantageously allows heat to be dissipated from the first cell pole connection via the coupling device to the heat conducting element via the cooling wall to the cooling device.

In a particularly advantageous embodiment of the disclosure, the first cooling wall has at least one integrated cooling channel through which a cooling medium can flow. This allows even more efficient cooling to be provided. The first cooling wall can also comprise several cooling channels through which a flow can pass and which are at least partially spatially separated from each other. This at least one cooling channel integrated in the cooling wall can also have a cooling medium flowing through it independently of the housing base. In other words, the housing base cooling and the side wall cooling can be designed independently of each other or they can be coupled. Nevertheless, the at least one cooling channel in the cooling wall and the cooling channels in the housing base can also be, in particular, fluidically coupled to one another. Again, a cooling liquid such as water, in particular a water-glycol mixture, is preferably suitable as a cooling medium. The at least one cooling channel can, for example, be formed as a through opening or bore extending in the third direction. Several such through openings, which run parallel to each other in the third direction, can also be provided. Alternatively, the side wall can also be designed as a hollow chamber profile through which the cooling medium can flow. Liquid cooling can provide a particularly high level of heat dissipation efficiency.

In another very advantageous embodiment of the disclosure, the heat conducting element is formed of an electrically conductive material, in particular a metal or an alloy, preferably aluminum. Metals or alloys in particular have a very high thermal conductivity, so that particularly efficient heat dissipation can be provided via the heat conducting element. As mentioned above, this can, for example, simply take the form of a suitably curved or shaped metal rail. Aluminum is particularly well suited for this purpose, as it is characterized on the one hand by its very high thermal conductivity, and on the other hand by its low weight and low cost.

In another highly advantageous embodiment of the disclosure, the coupling device comprises a conductor rail electrically conductively connected to the first cell pole connection, wherein the electrical insulation is arranged between the conductor rail and the heat conducting element, in particular wherein a portion of the electrical insulation is additionally arranged between an area of the upper side of the at least one first battery cell provided by a portion of a cell housing of the at least one first battery cell and the heat conducting element. Thus, the heat conducting element or the electrical insulation is not arranged directly on the first cell pole connection, but a conductor rail, which is also referred to as a busbar or cell connector, is first arranged on the first cell pole connection in an electrically conductive manner, the electrical insulation is in turn arranged on this conductor rail, and then the first connection area of the heat conducting element is arranged on this electrical insulation. Thus, the heat conducting element can be directly connected to the conductor rail via the electrical insulation. This allows particularly efficient heat dissipation from the conductor rail. The electrical insulation can be, for example, in the form of a thin layer with a maximum thickness of only a few millimeters. In addition, the electrical insulation does not necessarily have to be limited to the area of the conductor rail, but can also extend to other parts of the top of the battery cell provided by the cell housing, as mentioned above. Here, the cell housing areas that lie in the second direction between the cell pole connection and the first side wall are particularly advantageous. Also in the third direction, the electrical insulation may extend beyond the conductor rails. Furthermore, if the cell stack comprises multiple first battery cells arranged side by side, the electrical insulation may extend across multiple first battery cells. In other words, it is not necessary to provide one section of insulation per battery cell, or per conductor rail, but the electrical insulation can extend across all of the first battery cells of the first actuator stack. This allows a particularly simple and efficient formation and application of the electrical insulation. Furthermore, the electrical insulation is preferably arranged and designed in such a way that it is in positive contact on the one hand with the first connection area of the heat conducting element and on the other hand in positive contact with the underlying arrangement of battery cell, cell pole connection and conductor rail. In other words, it is preferred that the insulation completely fills the space between the heat conducting element and the assembly comprising the at least one battery cell, the first cell pole connection and the conductor rail in the first direction. On the one hand, this provides reliable electrical separation between electrically conductive parts, in particular the heat conducting element and the cell pole connection or cell housing or conductor rail, and on the other hand it prevents air pockets or air gaps that reduce the efficiency of heat transfer. In other words, this design of the electrical insulation allows particularly efficient thermal coupling to the heat conducting element. Preferably, a material that is as thermally conductive as possible is used as the electrical insulation, such as a thermally conductive paste or pad or similar. The electrical insulation may also be provided as a silicone insert adapted to a geometry of the heat conducting element and cell assembly as a negative mold.

In a further advantageous embodiment of the disclosure, the heat conducting element is simultaneously configured as a hold-down element which is designed to prevent movement of the at least one first battery cell in the first direction away from the housing base, and in particular to apply a counterforce to the at least one first battery cell in the direction of the housing base. In other words, the at least one first battery cell can be held in position with respect to a movement in the first direction by means of the heat conducting element. It is therefore advantageous to dispense with additional hold-down devices. This allows the heat conducting element to perform a dual function at the same time. In this case, the heat conducting element can be designed in such a way that it only applies the counterforce in the direction of the housing base to the at least one battery cell when, for example, the latter actively moves upwards relative to the side wall. However, it is preferred that such a counterforce in the form of a permanent contact force in the direction of the housing base on the at least one battery cell is provided by the heat conducting element. This improves the thermal connection to the heat conducting element on the one hand and the thermal connection to the cooling housing base on the other.

In another advantageous embodiment of the disclosure, the first cell stack comprises a plurality of the at least one first battery cell, wherein the plurality of first battery cells are juxtaposed in a third direction defining a stack longitudinal direction, and wherein the first cell pole connections of at least two of the first battery cells juxtaposed in the third direction are electrically conductively connected via the conductor rail. Depending on the number of battery cells, several conductor rails can be provided. Depending on the design of the electrical circuitry, only two adjacent battery cells or their connections can be electrically connected to each other via a conductor rail or, for example, four or more. If the plurality of first battery cells are arranged side by side in the second direction, it can also be easily accomplished that their first cell pole connections are arranged, for example, along a line in this third direction. Accordingly, the corresponding conductor rails also lie along such an imaginary line. This enables a particularly simple connection to the first side wall, which also runs in the stacking direction, via the heat conducting element.

In particular, it represents a further very advantageous embodiment of the disclosure if the heat conducting element extends continuously in the third direction across all first cell poles of the first cells of the first cell stack, and in particular also extends continuously in the second direction at least as far as the first side wall. In particular, the heat conducting element extends not only over all the first cell pole connections, but also over all the conductor rails electrically interconnecting the cell pole connections. This has the great advantage that only a single heat conducting element is required to connect all conductor rails, and thus all cell pole connections, to the cooling wall. This is also very easy to manufacture due to its continuous and one-piece design. In addition, this allows a particularly large line cross-section to be provided, which enables very efficient heat dissipation. Also, for example, the electrical insulation may extend continuously across all of the cell pole connections in the second direction, and in particular across all of the conductor rails interconnecting those cell pole connections. However, the electrical insulation extends in the second direction at most as far as the cooling wall, wherein it is preferred that the electrical insulation does not contact the cooling wall. At least the electrical insulation is not arranged between the heat conducting element, in particular the second connection area, and its cooling wall. The heat conducting element thus contacts the cooling wall directly in the second connection area, whereby the thermal resistance between the heat conducting element and the cooling wall can be minimized.

In another advantageous embodiment of the disclosure, it is provided that each of the first battery cells has a second cell pole connection on the upper side, wherein the first cell stack is arranged in the receiving area such that the respective cell pole connections are arranged closer to the first cooling wall than the second cell pole connections, and the first cell pole connections are arranged in the third direction along an imaginary line extending parallel to the first side wall. As mentioned above, this enables a particularly simple and cost-effective connection of the cell pole connections to the cooling wall. The heat conducting element can thus be formed continuously at a particularly simple geometric configuration in the third direction, so that the heat conducting element extends across all first cell poles and conductor rails. In this arrangement, the cell pole connections can also be arranged very close to the cooling wall, whereby also the heat conducting element can be minimized in its dimension in the second direction. The second cell pole connections can also be connected quite analogously to a cooling wall via a corresponding heat conducting element, wherein in this case the cooling wall is preferably located on a side opposite the first cooling wall, as will be explained in more detail later.

In another advantageous embodiment of the disclosure, the battery housing has a second receiving area with a second cell stack received therein, comprising at least one second battery cell having at least one third cell pole connection on an upper side, wherein the first side wall separates the first and second receiving areas from each other with respect to the second direction, wherein the battery has a second coupling device, and wherein the heat conducting element has a third application region connected to the at least one third cell pole connection of the at least one second battery cell via the second coupling device. Thus, since the cooling wall is also a partition wall between the first and second receiving areas, the cooling wall can be used simultaneously to cool the third cell pole connections and the conductor rails of a second cell stack disposed thereon. It is particularly advantageous that the third cell pole connections can be connected to the common cooling wall, namely the first cooling wall, via the same heat conducting element. The connection can be made in the same way as described for the first cell stack. In particular, the second coupling device can again provide electrical insulation, which is arranged in particular between the heat conducting element, in particular between its third connection area and a conductor rail, which is in turn arranged at at least one of the third cell pole connections. In other words, here again the third cell pole connections can be interconnected via conductor rails. Such a conductor rail thus connects at least two of the third cell pole connections of two second battery cells arranged adjacent in the third direction. On such a conductor rail is again arranged electrical insulation, and on it the third connection area of the heat conducting element. Thus, the second connection area of the heat conducting element is arranged between the first and third connection areas with respect to the second direction. Again, both the electrical insulation and the thermal conduction element may extend continuously in the third direction across all third cell pole connections and the conductor rails interconnecting them.

Furthermore, it is also advantageous, for example, if the battery housing comprises a second side wall, which is opposite the first side wall, which delimits the first receiving area with respect to the second direction, and which is formed as a second cooling wall, wherein the battery comprises a second heat conducting element and a third coupling device, wherein the second heat conducting element is connected to the at least one cell pole connection of the at least one first battery cell via the third coupling device, and is arranged on the second cooling wall. In other words, the side wall opposite the first cooling wall may also be a second cooling wall and used to cool the second cell pole connections via their contacted conductor rails. The connection to the second cooling wall is again made via a second heat conducting element, which can be designed quite analogously to the heat conducting element described so far, which can thus also be referred to as the first heat conducting element. If, for example, the second side wall does not represent a partition wall between two receiving areas but, for example, an outer wall of the battery housing, the second heat conducting element, in contrast to the first heat conducting element, does not have a third connection area, but only has a first connection area, via which the latter is connected to the coupling device, in this case the third coupling device, and a second connection area, via which the second heat conducting element is connected directly to the second cooling wall, in particular on a side of the second cooling wall opposite the housing base. The second cooling wall can also be designed in the same way as the first cooling wall and, for example, have integrated cooling channels through which a coolant can flow. Thus, a particularly efficient connection of the respective cell poles and the conductor rail electrically contacted with them to a cooling wall can be provided.

Furthermore, the disclosure also relates to a motor vehicle with a battery according to the disclosure or one of its embodiments. The advantages described for the battery according to the disclosure and its embodiments apply in the same way to the motor vehicle according to the disclosure.

The motor vehicle according to the disclosure is preferably designed as a motor vehicle, in particular as a passenger car or truck, or as a passenger bus or motorcycle.

The disclosure also includes combinations of the features of the described embodiments. Thus, the disclosure also includes implementations each having a combination of the features of more than one of the described embodiments, provided that the embodiments have not been described as mutually exclusive.

### DETAILED DESCRIPTION OF THE FIGURES

Examples of embodiments of the disclosure are described below. Showing for this purpose:

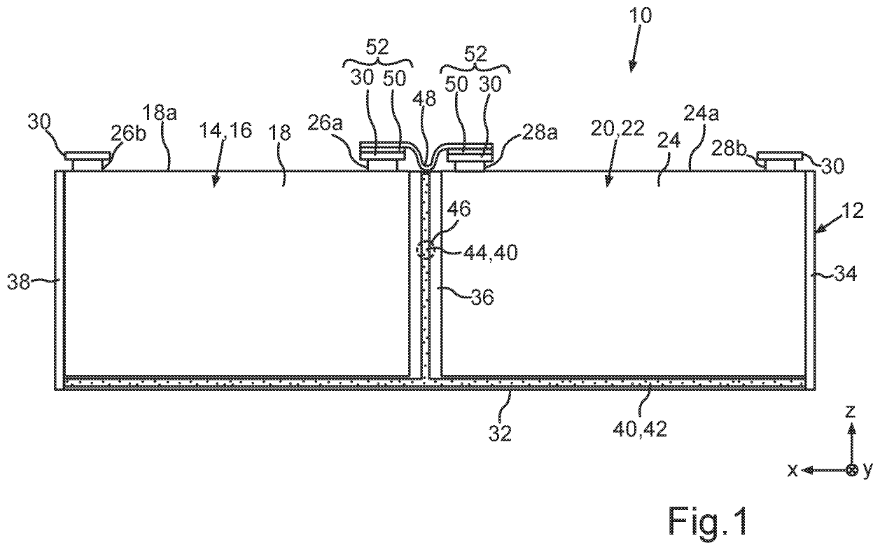

FIG. 1 a schematic diagram of a battery with a battery housing with integrated busbar cooling system in a cross-sectional view according to an exemplary embodiment of the disclosure; and

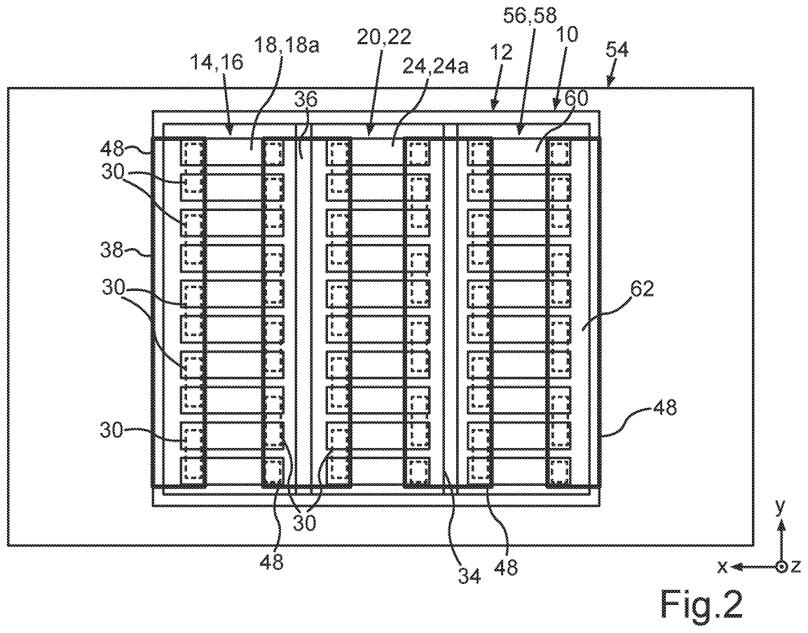

FIG. 2 a schematic representation of a motor vehicle with a battery according to an exemplary embodiment of the disclosure in a plan view.

### DETAILED DESCRIPTION

The embodiments explained below are preferred exemplary embodiments of the disclosure. In the exemplary embodiments, the described components of the embodiments each represent individual features of the disclosure that are to be considered independently of one another, and which also each independently further the disclosure. Therefore, the disclosure is intended to include combinations of the features of the embodiments other than those shown. Furthermore, the described embodiments can also be supplemented by further of the already described features of the disclosure.

In the figures, identical reference signs denote elements with identical functions.

FIG. 1 shows a schematic cross-sectional view of a battery 10 according to an embodiment of the disclosure. In this regard, the battery 10 includes a battery housing 12. In this example, this battery housing 12 provides a first receiving area 14 in which a first cell stack 16 having a plurality of first battery cells 18 is disposed, and a second receiving area 20 in which a second cell stack 22 having a plurality of second battery cells 24 is disposed. A respective cell stack 16, 22 thus comprises several battery cells 18, 24, which are arranged next to each other in the y-direction shown here. In the illustration in FIG. 1, therefore, only one battery cell 18, 24 can be seen per cell stack 16, 22. A respective battery cell 18, 24 has an upper side 18a, 24a on which two cell pole connections 26a, 26b and 28a, 28b are arranged in each case. One of the two cell pole connections 26a, 26b, 28a, 28b is designed as a positive pole, the other as a negative pole. The cell pole connections 26a, 26b, 28a, 28b are further interconnected via conductor rails 30. In particular, those cell pole connections 26a, 26b, 28a, 28b which belong to a same cell stack 16, 22 and also belong to directly adjacent battery cells 18, 24 in the y-direction are interconnected via such conductor rails 30. The respective receiving areas 14, 20 are here bounded on the one hand by the battery housing 12 downwardly by a housing base 32 of the battery housing 12, and with respect to a second direction, namely the x-direction shown here, by respective side walls 34, 36, 38. For example, the two outermost side walls 34, 38 may provide outer walls of the battery housing 12, while the middle side wall 36 provides a common side wall with respect to the two receiving areas 14, 20, or a partition wall of these two receiving areas 14, 20. The housing base 32 is designed as a cooling base and for this purpose has cooling channels 42 through which, for example, a coolant 40 can flow. In addition, a busbar cooling system is now also advantageously integrated into this battery housing 12. This is provided on the one hand by the fact that the side walls 34, 36, 38, which delimit the receiving areas in the x-direction, are designed as cooling walls. This is illustrated in FIG. 1 as an example for the center partition wall 36. These side walls 34, 36, 38 can also be formed accordingly with cooling channels 44 through which a coolant 40 can flow. These cooling channels 44 may be provided, for example, as through-holes in the y-direction, of which a through-hole 46 in the central side wall 36 is shown here as an example. Thus, coolant routing is provided via these channels 44. Further, the battery 10 advantageously includes a heat conducting element 48 which acts as a thermal bridge. This heat conducting element 48 is connected on the one hand to the cell pole connections 26a, 28a in the present example, and on the other hand to the cooling wall 36. An electrical insulator 50 is also disposed between the conductor rail 30 and this heat conducting element 48, which is preferably formed of aluminum. The combination of the conductor rail 30 and this electrical insulation 50 may be considered a coupling element or coupling device 52 through which the heat conducting element 48 is connected to the respective cell pole connection 26a, 28a. The electrical insulation 50 is preferably formed from a plastic. Further, this is preferably configured to fill the entire area in the z-direction between the conductor rail 30 and the heat conducting element 48. In this regard, the electrical insulation 50 need not necessarily be limited to the area of the conductor rail 30, but may further extend to other areas of the upper side 18a, 24a of the cell housing. Although such a heat conducting element 48 is shown for only one of the two cell poles 26a, 28a of a respective battery cell 18, 24 of a respective cell stack 16, 22, a connection of the other cell pole connections 26b, 28b via their conductor rails 30 can be made quite analogously. In other words, a corresponding insulation 50 may also be arranged on these conductor rails 30, and on this insulation in turn a heat conducting element 48, which on the other hand is coupled to or arranged on the outer sides 38, 34 of the battery housing 12. This allows particularly simple and efficient cooling to be implemented. It is also particularly advantageous that adjacently arranged cell stacks 16, 22 can utilize a common partition wall 36 and a common heat conducting element 48 for cooling.

FIG. 2 shows a schematic representation of a motor vehicle 54 with a battery 10 arranged therein, in accordance with a further exemplary embodiment of the disclosure. This battery 10 is shown here in a plan view and can be designed generally as already described for FIG. 1, in particular except for the differences described below. In the present example, in addition to the two cell stacks 16, 22 in corresponding receiving areas 14, 20, a third cell stack 56 is provided in a third receiving area 58. This third cell stack 56 may again include a plurality of battery cells 60 arranged side by side in the y-direction. These are also connected and interconnected via respective conductor rails 30, which are shown here as dashed lines. In this example, the outer wall 34 described with respect to FIG. 1 is consequently not an outer wall of the battery housing 12, but likewise a partition wall separating the two receiving areas 20, 58 from one another, in particular in the x-direction. The third receiving area 58 is bounded in the x-direction against another side wall 62. Thus, in the present example, the side walls 38, 36, 34, 62 may be cooling walls. In addition, the respective heat conducting elements 48 are also shown schematically here. These are in turn separated from the respective conductor rails 30 by electrical insulation 50, but this is not explicitly shown here. As can be seen here, a respective heat conducting element 48 extends continuously in the y-direction across all of the cell pole connections and the conductor rails 30 that make electrical contact therewith. The heat conducting elements can be designed as three-dimensionally shaped plates, so to speak. In addition, the heat conducting elements 48 may be attached to the respective cooling walls 38, 36, 34, 62, in particular on the side opposite the cooling base 32, for example glued on, welded on, screwed on or the like. Moreover, the thermal bridges, i.e. the thermal conduction elements 48, can also be used at the same time as hold-downs for the cells 18, 24, 60. In order to design the respective side walls as cooling walls, the distance between the cell stacks, i.e. the cell stacks 16, 20, 56, can be increased and thus coolant guides can be easily integrated into the intermediate housing wall. The same applies to the outer walls. So from there, thermal bridges can be electrically isolated to the connections and busbars.

Overall, the examples show how the disclosure can provide a battery housing with integrated busbar cooling system, by means of which the cells, connections and busbars can be cooled. Furthermore, in case of thermal runaway of a cell, neighboring cells are not heated and their thermal runaway is prevented. Furthermore, there are no coolant-carrying parts inside the battery and leakage over service life is therefore not possible.

1. A battery for a motor vehicle, wherein the battery comprises:
a battery housing with a first receiving area, a housing base which bounds the receiving area with respect to a first direction, and at least one first side wall arranged on the housing base which bounds the receiving area with respect to a second direction,
at least one first cell stack with at least one first battery cell having a first cell pole connection on an upper side, wherein the at least one first cell stack is disposed in the first receiving area, and
wherein the first sidewall is formed as a first cooling wall, and the battery has at least one heat conducting element and a coupling device comprising an electrical insulation, wherein the heat conducting element has a first connection area connected via the coupling device to the first cell pole connection of the at least one first battery cell and a second connection area arranged at the first cooling wall.

2. The battery according to claim 1, wherein the first cooling wall has at least one integrated cooling channel through which a cooling medium can flow.

3. The battery according to claim 1, wherein the heat conducting element is formed of an electrically conductive material, in particular a metal or an alloy, preferably aluminum.

4. The battery according to claim 1, wherein the coupling device comprises a conductor rail electrically conductively connected to the first cell pole connection, wherein the electrical insulation is arranged between the conductor rail and the heat conducting element, in particular wherein a part of the electrical insulation is additionally arranged between an area of the upper side of the at least one first battery cell provided by a part of a cell housing of the at least one first battery cell and the heat conducting element.

5. The battery according to claim 1, wherein the heat conducting element is simultaneously formed as a hold-down element, which is designed to prevent a movement of the at least one first battery cell in the first direction away from the housing base, and in particular to apply a counterforce in the direction of the housing base to the at least one first battery cell.

6. The battery according to claim 1, wherein the first cell stack comprises a plurality of the at least one first battery cell, wherein the plurality of first battery cells are juxtaposed in a third direction defining a stack length direction, wherein the first cell pole connections of at least two of the first battery cells juxtaposed in the third direction are electrically conductively connected via the conductor rail.

7. The battery according to claim 1, wherein the heat conducting element extends in the third direction continuously over all the first cell pole connections of the first battery cells of the first cell stack, and in particular also extends in the second direction continuously at least up to the first side wall.

8. The battery according to claim 1, wherein each of the first battery cells has a second cell pole connection on the upper side, wherein the first cell stack is arranged in the receiving area such that the respective first cell pole connections are arranged closer to the first cooling wall than the second cell pole connections, and the first cell pole connections are arranged in the third direction along an imaginary line extending parallel to the first side wall.

9. The battery according to claim 1, wherein the battery housing has a second receiving area with a second cell stack received therein, which comprises at least one second battery cell having at least one third cell pole connection on an upper side, wherein the first side wall separates the first and second receiving areas from each other with respect to the second direction, wherein the battery has a second coupling device, and wherein the heat conducting element has a third connection area connected via said second coupling device to the at least one third cell pole connection of the at least one second battery cell.

10. The battery according to claim 2, wherein the heat conducting element is formed of an electrically conductive material, in particular a metal or an alloy, preferably aluminum.

11. The battery according to claim 2, wherein the coupling device comprises a conductor rail electrically conductively connected to the first cell pole connection, wherein the electrical insulation is arranged between the conductor rail and the heat conducting element, in particular wherein a part of the electrical insulation is additionally arranged between an area of the upper side of the at least one first battery cell provided by a part of a cell housing of the at least one first battery cell and the heat conducting element.

12. The battery according to claim 3, wherein the coupling device comprises a conductor rail electrically conductively connected to the first cell pole connection, wherein the electrical insulation is arranged between the conductor rail and the heat conducting element, in particular wherein a part of the electrical insulation is additionally arranged between an area of the upper side of the at least one first battery cell provided by a part of a cell housing of the at least one first battery cell and the heat conducting element.

13. The battery according to claim 2, wherein the heat conducting element is simultaneously formed as a hold-down element, which is designed to prevent a movement of the at least one first battery cell in the first direction away from the housing base, and in particular to apply a counterforce in the direction of the housing base to the at least one first battery cell.

14. The battery according to claim 3, wherein the heat conducting element is simultaneously formed as a hold-down element, which is designed to prevent a movement of the at least one first battery cell in the first direction away from the housing base, and in particular to apply a counterforce in the direction of the housing base to the at least one first battery cell.

15. The battery according to claim 4, wherein the heat conducting element is simultaneously formed as a hold-down element, which is designed to prevent a movement of the at least one first battery cell in the first direction away from the housing base, and in particular to apply a counterforce in the direction of the housing base to the at least one first battery cell.

16. The battery according to claim 2, wherein the first cell stack comprises a plurality of the at least one first battery cell, wherein the plurality of first battery cells are juxtaposed in a third direction defining a stack length direction, wherein the first cell pole connections of at least two of the first battery cells juxtaposed in the third direction are electrically conductively connected via the conductor rail.

17. The battery according to claim 3, wherein the first cell stack comprises a plurality of the at least one first battery cell, wherein the plurality of first battery cells are juxtaposed in a third direction defining a stack length direction, wherein the first cell pole connections of at least two of the first battery cells juxtaposed in the third direction are electrically conductively connected via the conductor rail.

18. The battery according to claim 4, wherein the first cell stack comprises a plurality of the at least one first battery cell, wherein the plurality of first battery cells are juxtaposed in a third direction defining a stack length direction, wherein the first cell pole connections of at least two of the first battery cells juxtaposed in the third direction are electrically conductively connected via the conductor rail.

19. The battery according to claim 5, wherein the first cell stack comprises a plurality of the at least one first battery cell, wherein the plurality of first battery cells are juxtaposed in a third direction defining a stack length direction, wherein the first cell pole connections of at least two of the first battery cells juxtaposed in the third direction are electrically conductively connected via the conductor rail.
